(19) United States
(12) Patent Application Publication
(10) Pub. No.: US 2006/0010982 A1
(43) Pub. Date: Jan. 19, 2006

(54) Method and apparatus for indicating an apparent error in the operation of a fluid-powered attachment

(75) Inventors: Paul W. Allart, Rochester, NY (US); Liberato Pietrantoni, Rochester, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: Brinkman Products, Inc.

(21) Appl. No.: 11/225,668

(22) Filed: Sep. 13, 2005

Related U.S. Application Data
(63) Continuation-in-part of application No. 10/806,708, filed on Mar. 23, 2004, now abandoned.

(51) Int. Cl. G01L 7/00

(52) U.S. Cl. 73/714

(57) ABSTRACT

The invention provides an improved method and apparatus for indicating an apparent error in the operation of a fluid-powered attachment (A) mounted on a machine tool for controlled movement toward and away from a workpiece (W) upon which an operation (e.g., thread rolling, knurling, burnishing, etc.) is to be performed during a cycle. The improved apparatus (60) broadly includes: a fluid-powered actuator (64) for selectively moving the attachment (A) relative to workpiece (W) during the cycle; a sensor (73) operatively arranged to monitor the value of at least one of the pressure within the actuator, and the time of operation, during at least a portion of the cycle, and arranged to provide an output signal; and a programmable logic unit (75) provided with the sensor output signal, arranged to store minimum and maximum permissible values of the selected pressure and/or time of operation, and operatively arranged to indicate an apparent error in the performance of the operation on the workpiece if the sensed value is not between the stored minimum and maximum stored values.

### CROSS-REFERENCE TO RELATED APPLICATION

This application is a continuation-in-part of pending U.S. patent application Ser. No. 10/806,708, filed Mar. 23, 2004.

### TECHNICAL FIELD

The present invention relates generally to a method and apparatus adapted for use in a cold-forming process (e.g., thread rolling, knurling, burnishing, etc.) for indicating an apparent error in the operation of a fluid-powered attachment mounted on a machine tool for controlled movement toward and away from a workpiece.

### BACKGROUND ART

Various types of cold-forming processes are known. These processes include, but are not limited to, thread rolling, knurling, burnishing, etc. Some of these contemplate that a fluid-powered attachment be mounted on a machine tool for selective and controlled movement relative to a workpiece. In some devices, thread rolls are moved generally tangentially toward the workpiece. (See, e.g., U.S. Pats. No. 4,617,816, 4,766,750, 5,167,136 and 6,202,461, the aggregate disclosures of which are hereby incorporated by reference.) Alternatively, they may be initially moved to a radially-spaced position relative to the relatively-rotating workpiece, and then moved radially inwardly to roll a thread on the workpiece. (See, e.g., U.S. Pat. No. 6,508,095, the disclosure of which is hereby also incorporated by reference.)

In many cases, these devices and attachments are mounted on machine tools, and generally operate on a substantially unattended basis. Accordingly, it would be generally desirable to provide a means for automatically indicating that an error has apparently occurred during the cold-forming operation.

### DISCLOSURE OF THE INVENTION

With parenthetical reference to the corresponding parts, portions or surfaces of the disclosed embodiment, merely for purposes of illustration and not by way of limitation, the present invention broadly provides an improved method and apparatus for indicating an apparent error in the operation of a fluid-powered attachment (A) that is mounted on a machine tool (not shown) for controlled movement toward and away from a workpiece (W) upon which an operation is to be performed. Such an attachment may possibly be used in a cold-forming operation or process, such as thread rolling, knurling, burnishing, or the like. However, the invention is not limited to cold-forming processes, or to any of these specific operations. As used herein, the term “fluid” is intended to broadly include a liquid, a gas, or a mixture thereof.

The improved apparatus (60) may broadly include: a fluid-powered actuator (64) for selectively moving the attachment (A) relative to the workpiece (W) during an operational cycle; a sensor (73) operatively arranged to sense and monitor the value of at least one of the pressure of fluid within the actuator, and the time of operation, during at least a portion of the cycle, and to provide an output signal; and a programmable logic unit (75) provided with the sensor output signal, arranged to store minimum and maximum permissible values of said sensed pressure and/or time that the attachment is expected to encounter during the cycle, and operatively arranged to indicate an apparent error in the formation of a thread on the workpiece if the sensed value is not between these stored minimum and maximum values.

In the preferred embodiment, the sensor is arranged to continuously monitor the selected pressure and/or time.

The invention also provides an improved method of indicating an apparent error in the operation of a fluid-powered attachment (A) mounted on a machine tool (not shown) for controlled movement toward and away from a workpiece (W) upon which an operation is to be formed. This method may broadly include the steps of: providing a fluid-powered actuator (64) for selectively moving the attachment relative to the work-piece during an operational cycle; storing minimum and maximum permissible values of at least one of the fluid pressure within said actuator, and the time of operation, expected during said cycle; sensing the value of the selected pressure and/or time during at least a portion of said cycle, and providing an output signal; determining whether the sensed value is between said stored minimum and a maximum permissible values; and indicating an apparent error in the formation of a thread on the workpiece if the sensed value is not between the stored minimum and maximum values.

The method may further include the additional steps of: providing a programmable logic unit (75); supplying the programmable logic unit with the sensed value; storing the minimum and maximum permissible values in the programmable logic unit; and comparing the sensed value with the stored values.

Accordingly, the general object of the invention is to provide an improved apparatus for indicating an apparent error in the operation of a fluid-powered attachment.

Another object is to provide an improved method of indicating an apparent error in the operation of a fluid-powered attachment.

Still another object is to provide such an improved method in a device wherein an attachment is adapted to be mounted on a machine tool for controlled movement toward and away from a workpiece upon which a particular operation is to be formed during a cycle.

These and other objects and advantages will become apparent from the foregoing and ongoing written specification, the drawings, and the appended claims.

### BRIEF DESCRIPTION OF THE DRAWINGS

FIG. 1 is a simplified schematic of a prior art apparatus for operating a fluid-powered attachment.

FIG. 2 is a schematic, more detailed than FIG. 1, showing the improved apparatus according to the present invention.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

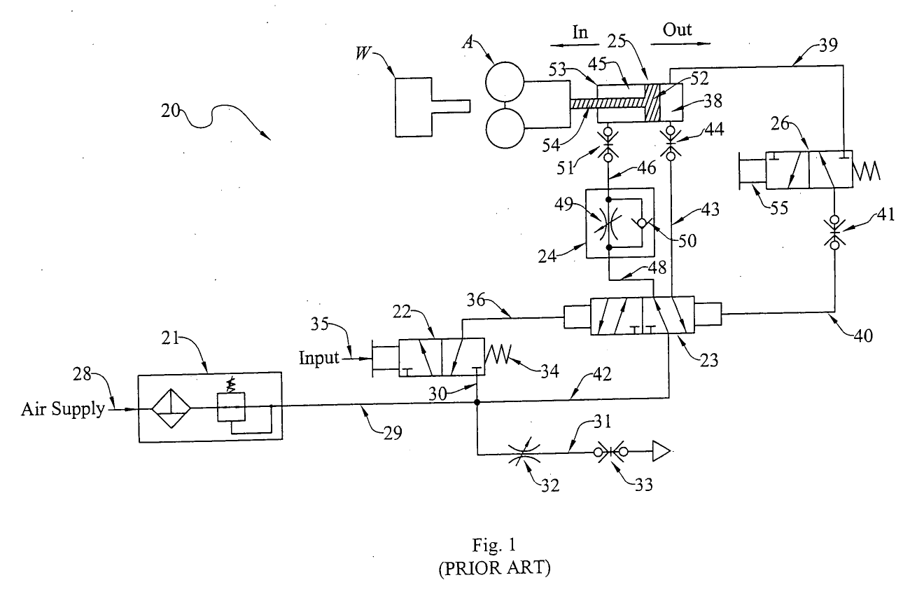

Prior Art Arrangement (FIG. 1)

FIG. 1 is a schematic depicting a prior art arrangement for operating a thread-rolling attachment (A) on a machine tool (not shown). The circuit is generally indicated at 20, and is shown as broadly including a filter/pressure regulator assembly 21, a control valve 22, an operator valve 23, a flow control valve 24, a fluid-powered actuator 25, and a reset/return actuator 26.

Compressed air is provided from a suitable source (not shown) through a line 28 as an inlet to filter/regulator 21. This block incorporates a fluid filter and a pressure regulator, and provides an output flow through line 29. The flow in line 29 is provided to control valve 22 via line 30, and is also provided to line 31, which contains a flow-control purge line 32 and a quick-disconnect plug 33.

Control valve 22 is schematically shown as having a manually-operated valve spool that is slidably mounted within a body. The spool is biased toward its leftward position by a spring 34. An input, indicated by arrow 35, is arranged to selectively displace the spool rightwardly to the alternative position by overcoming the bias of spring 34. When this occurs, fluid in lines 29 and 30 may flow through control valve 22 and line 36 to act on the left end face of a valve spool located within operator valve 23. The right end face of this valve spool is provided with pressure from large-area chamber 38 of actuator 25 via line 39, reset valve 26 and line 40. Line 40 is also shown as containing a quick-disconnect 41.

In the condition shown, flow in line 39 from the large-area actuator chamber 38 is initially blocked by virtue of reset valve 26 being in the position shown in FIG. 1. However, the right end chamber of operator valve 23 is vented to return via line 40 and the reset valve. Thus, when control valve 22 is displaced to the alternative position, line 36 is pressurized, and the spool of operator valve 23 is shifted rightwardly to the alternative position. Thus, compressed air may flow from line 29 through line 42, the now-displaced operator valve 23 and line 43 to actuator large-diameter chamber 38. Line 43 is shown as including a quick-disconnect 44. At the same time, the fluid may flow from actuator small-diameter chamber 45 through line 46 and filter/regulator 24, and line 48 to now-displaced operator valve 23, and thence to exhaust. Filter/regulator assembly 24 is shown as having a variable orifice 49 and a check valve 50. Line 46 is shown as having a quick-disconnect 51. The actuator 25 is shown as having a piston 52 movable relative to a cylinder 53, and having a rod 54 extending leftwardly from the piston and penetrating the left end wall of the cylinder. Thus, the piston has a large circular area facing rightwardly into chamber 38 and a smaller annular area facing leftwardly into chamber 45.

When fluid pressure is provided to actuator chamber 38 and actuator chamber 45 is vented, the thread-rolling attachment is moved leftwardly toward the workpiece. At the end of its stroke, the thread-rolling attachment displaces a plunger 55 on the reset valve 26 so as to shift the reset valve to the alternative position. When so shifted, pressure in the large actuator chamber 38 is provided via conduits 39 and 40 to the operator valve right end chamber, and displaces its valve spool leftwardly and back to the position shown. This permits fluid in actuator chamber 38 to be vented to return via line 43.

The arrangement indicated by FIG. 1 is substantially automatic in that each time a thread is to be rolled, one need only to actuate the input device 35, either manually or by some other means. This then causes the actuator to advance the thread rolls toward the workpiece. At the end of its intended stroke, the reset button is actuated, which causes the actuator to return to its initial position.

While this arrangement is functional to cause automatic operation of the device (i.e., to advance the thread-rolls to engage the workpiece, and then to automatically withdraw them at the end of their desired stroke), this arrangement did not have any type of mechanism for indicating whether an apparent error had occurred during operation of the device.

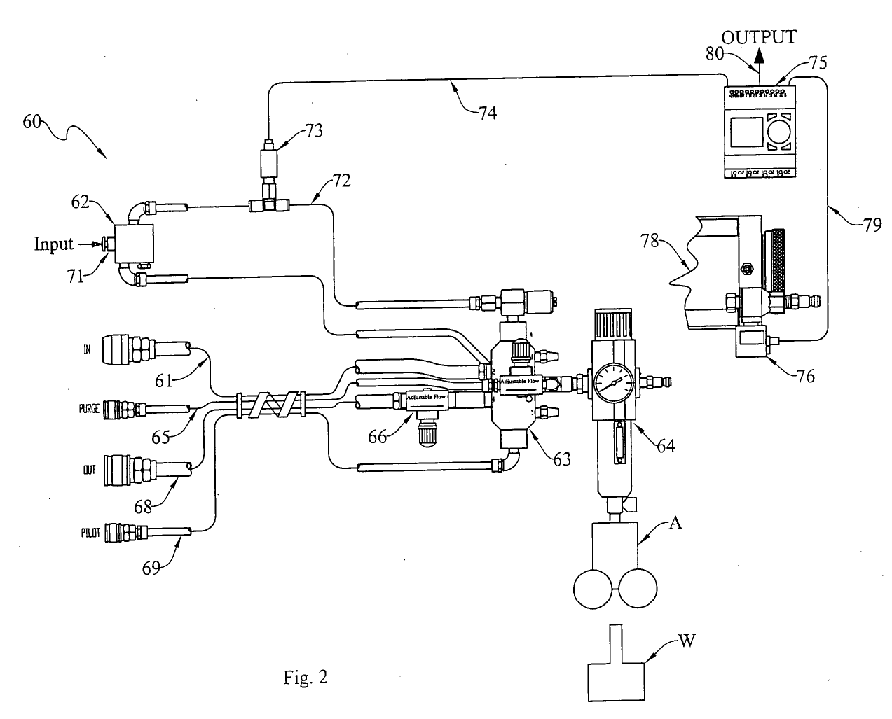

Improved Device (FIG. 2)

An improved device is generally indicated at 60 in FIG. 2.

Device 60 is arranged to be supplied with compressed air from a suitable source (not shown) via inlet 61, and further contains a control valve 62, an operator valve 63, a fluid-powered actuator 64 upon which the thread-rolling attachment (A) is mounted, and an operating valve 67. In the illustrated form, the attachment is used to roll a thread onto the workpiece. In other forms, the attachment might relate to another cold-forming process or operation, such as knurling or burnishing. However, the invention is not limited to such cold-forming processes or operations.

An outlet line is indicated at 65, and a pilot line is indicated at 66. Lines 65, 66, 68 and 69 are each provided to operator valve 63. Pilot line 66 is connected to an end chamber of the pilot valve, and is operatively arranged to act on one end of the valve spool therein. The inlet 61 communicates with a line 70 which communicates with control valve 62 having an input 71. Control valve 62 also communicates with the opposite end of the operator valve spool via line 72.

In this form, a pressure sensor 73 is operatively arranged to monitor the pressure in line 72, and to provide this a corresponding signal via line 74 to a programmable logic unit 75.

Another pressure sensor 76 is mounted on actuator 64, and provides a pressure-indicating signal via line 79 to the programmable logic unit. The logic unit is adapted to store two set points, these representing the minimum and maximum pressures (pₘᵢₙ and pₘₐₓ, respectively) expected during a normal thread-rolling cycle. So long as the pressure provided by sensor 73 is between the minimum and maximum pressures, the output signal from the programmable logic unit will indicate that the apparatus is operating normally. However, should the pressure exceed either limit, either by falling below the minimum, or by exceeding the maximum, the programmable logic unit will provide an error signal on output line 80 to indicate an apparent error in the thread-rolling operation. Pressure sensor 76 is used as an alternative to the reset arrangement shown in the prior art.

Alternatively, or in addition thereto, the apparatus may be arrange to sense or determine the time of operation during at least a portion of the cycle, and to provide an output signal; and to compare such sensed time with minimum and maximum permissible times of operation stored in the programmable logic unit

Thus, the present invention broadly provides an improved method and apparatus for indicating an apparent error in the operation of a fluid-powered attachment mounted on a machine tool for controlled movement toward and away from a workpiece upon which an operation is to be performed during an operational cycle. The improved apparatus may broadly include: a fluid-powered actuator for selectively moving the attachment relative to the workpiece during the cycle; a sensor operatively arranged to monitor the value of at least one of the pressure of fluid within the actuator, and the time of operation, during at least a portion of the cycle, and to provide an output signal; and a programmable logic unit provided with the sensor output signal, arranged to store minimum and maximum permissible values of said selected pressure and/or time of operation that the apparatus is expected to encounter during the thread-forming cycle, and operatively arranged to indicate an apparent error in the operation of the attachment on the workpiece if the sensed value is not between the stored minimum and maximum values.

The improved method broadly includes the steps of: providing a fluid-powered actuator for selectively moving the attachment relative to the workpiece during the cycle; storing minimum and maximum permissible values of at least one of the fluid pressure, and time of operation, expected during the cycle; sensing the value of at least one of the pressure within the actuator, and the time of operation, during at least a portion of the cycle, and providing an output signal; determining whether the sensed value is between the stored minimum and maximum permissible values; and indicating an apparent error in the operation of the attachment on the workpiece if the sensed value is not between the minimum and maximum stored values.

The apparent error signal, provided by programmable logic unit output 80, may take any of a number of forms. For example, it may be in the form of a visual or audible indication, or it may be in the form of an automatic shut-down of the machine until such time as the apparent error may be investigated and the system reset. Other forms of error signals may be used as well.

Modifications

The present invention expressly contemplates that many changes and modifications may be made. For example, the method and apparatus is not limited to the specific form of the elements and circuitry shown in the accompanying drawings. Indeed, other types of apparatus may be substituted therefor. The pressure sensor may be electronic or pneumatic, as desired. Devices other than in the specific programmable logic unit, may be substituted therefor.

Therefore, while the presently-preferred form of the method and apparatus have been shown and described, and several modifications thereafter discussed, persons skilled in this art will readily appreciate that various additional changes and modifications may be made without departing from the spirit of the invention, as defined and differentiated by the following claims.

What is claimed is:

1. Apparatus for indicating an apparent error in the operation of a fluid-powered attachment mounted on a machine tool for controlled movement toward and away from a workpiece upon which an operation is to be performed, comprising:
a fluid-powered actuator for selectively moving said attachment relative to said workpiece during a cycle;
a sensor operatively arranged to monitor the value of at least one of the pressure of fluid within said actuator, and the time of operation, during at least a portion of said cycle, and to provide an output signal;
a programmable logic unit provided with said sensor output signal, arranged to store minimum and maximum permissible values of said selected pressure and/or time of operation, expected during said cycle, and operatively arranged to indicate an apparent error in the performance of the operation on said workpiece if the sensed value is not between said stored minimum and maximum values.

2. The apparatus as set forth in claim 1 wherein said sensor is arranged to continuously monitor the selected pressure and/or time of operation.

3. The apparatus as set forth in claim 1 wherein said operation is one of thread rolling, knurling and burnishing.

4. The method of indicating an apparent error in the operation of a fluid-powered attachment mounted on a machine tool for controlled movement toward and away from a workpiece upon which an operation is to be performed, comprising the steps of:
providing a fluid-powered actuator for selectively moving said attachment relative to said workpiece during a cycle;
storing minimum and maximum permissible values of at least one of the fluid pressure within said actuator, and the time of operation, expected during said cycle;
sensing the value of the selected pressure and/or time during at least a portion of said cycle, and providing an output signal;
determining whether said sensed value is between said stored minimum and a maximum permissible values; and
indicating an apparent error in the performance of the operation on said workpiece if said sensed value is not between said stored minimum and maximum values.

5. The method as set forth in claim 4, and further comprising the additional steps of:
providing a programmable logic unit;
supplying said programmable logic unit with said sensed value; and
storing said minimum and maximum values in said programmable logic unit.
